(19) United States
(12) Patent Application Publication
(10) Pub. No.: US 2009/0040355 A1
(43) Pub. Date: Feb. 12, 2009

(54) Electronic mirror

(76) Inventor: Chung-Jen Huang, Sheung Shui (HK)

Correspondence Address: ROSENBERG, KLEIN & LEE, 3458 ELLICOTT CENTER DRIVE-SUITE 101, ELLICOTT CITY, MD, 21043, US

(21) Appl. No.: 11/984,569

(22) Filed: Nov. 20, 2007

(30) Foreign Application Priority Data
Aug. 9, 2007 (TW) 96213137

(51) Int. Cl. H04N 5/222

(52) U.S. Cl. 348/333.01; 348/E05.022

(57) ABSTRACT

An electronic mirror includes: a partially transparent display screen, an image sensor set on a surface of the partially transparent display screen to capture an image of an observer located in one side of the partially transparent display screen as a first image; and a mainbody set in another side of the partially transparent display screen and electrically connected with the image sensor to receive the first image and process it as a second image, then project the second image onto the partially transparent display screen for displaying a third image which can be seen by the observer.

### BACKGROUND OF THE INVENTION

1. Field of the Invention

The present invention generally relates to a mirror, and more particularly relates to an electronic mirror.

2. Description of the Prior Art

Mirror is a necessity for people to dress or make up in the daily life since the ancient time.

It is well-known that the conventional mirror utilizes the surface reflection principle, which means an observer can see his own image by situating at the side in front of a smooth mirror surface. However, the observer can just only see his reflective image; he can not store the image or process the image.

During the recent years, versatile electronic devices progress rapidly along with the quick development of the society and the technology. There are many kinds of display and projection electronic devices, such as the front projection display, the rear projection display, the Liquid Crystal Display (LCD) projector, the Digital Light Processing (DLP) and Liquid Crystal on Silicon (LCOS) projector. Meanwhile, many kinds of image sensors, such as the Complementary Metal-Oxide-Semiconductor (CMOS), Charge Coupled Device (CCD), are widely applied for the electronic apparatuses having image capturing function.

Accordingly, how to combine the modern technology of image capturing, projection and display to realize an electronic mirror having the ability of image storage and process is an important issue nowadays.

### SUMMARY OF THE INVENTION

To solve the aforementioned problems, one object of the present invention is to provide an electronic mirror, which may make the observer to see the processed image of his own, and so as to achieve an electronic mirror having the function of image storage or process by utilizing the modern technology.

One object of the present invention is to provide an electronic mirror that the image of the observer may be magnified to a large-scale image by projection, thus the observer may comfortably see his own clear image when dressing or making up.

Another object of the present invention is to provide an electronic mirror that includes a partially reflective screen and an image display device, the observer may see his own image through the partially reflective screen when the mainbody is turned-off and the partially reflective screen will display the content provided by the image display device when the mainbody is turned-on.

Another object of the present invention is to provide an electronic mirror that includes an object sensing device to detect a user in the neighborhood of a partially reflective screen to turn-on an image display device.

Another object of the present invention is to provide an electronic mirror that includes a micro control unit to magnify, deform, rotate or beautify the observer's image or add a background image.

Another object of the present invention is to provide an electronic mirror having a switch that the electronic mirror is preformed as a regular mirror when the switch is turned-off.

Another object of the present invention is to provide an electronic mirror having a data access module to receive and store an image data, which the electronic mirror may project the image data onto a display screen.

Another object of the present invention is to provide an electronic mirror having a network access module to receive and store an image data from a network, which the electronic mirror may project the image data onto a display screen and different electronic mirrors may interchange and share the image data through the network access module and the network.

Another object of the present invention is to provide an electronic mirror having a voice module that the observer may interact with the mainbody of the electronic mirror through the voice module, which has the advantages of observer interaction, simple structure and relative cheapness. Furthermore, the electronic mirror may be widely applied as a distance communication equipment, an entertainment appliance or a children toy.

In accordance with the above objectives and other purposes of the present invention, an embodiment of an electronic mirror is provided, which includes: a display device, wherein the display device is a partially transparent display screen; an image sensor set on a surface of the partially transparent display screen to capture an image of an observer located in one side of the partially transparent display screen as a first image; and a mainbody set in another side of the partially transparent display screen and electrically connected with the image sensor through a signal transmission line, wherein the mainbody comprises a projection device to receive the first image and process the first image as a second image, then to project the second image onto the partially transparent display screen for displaying a third image which can be seen by the observer.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a structure and application schematic diagram of an electronic mirror according to an embodiment of the present invention; and

FIG. 2 is a structure schematic diagram of a mainbody for the electronic mirror according to an embodiment of the present invention.

### DESCRIPTION OF THE PREFERRED EMBODIMENT

Other advantages of the present invention will become apparent from the following description taken in conjunction with the accompanying drawings wherein are set forth, by way of illustration and example, certain embodiments of the present invention.

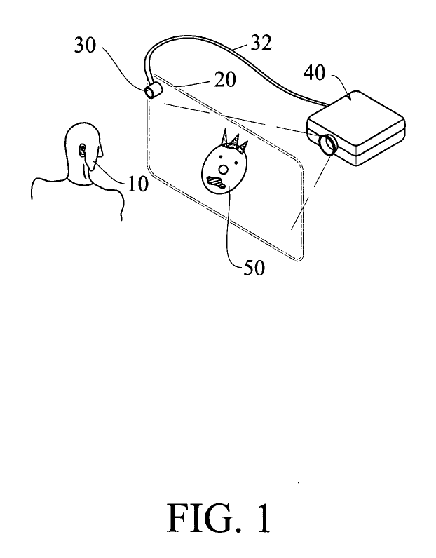

Please refer to FIG. 1, which is a structure and application schematic diagram of an electronic mirror according to an embodiment of the present invention. An observer 10 is located in one side of the partially transparent display screen 20; an image sensor 30 is set on a surface of the partially transparent display screen 20 to capture the image of the observer 10 as a first image; a mainbody 40 is set in another side of the partially transparent display screen 20 and electrically connected with the image sensor 30 through a signal transmission line 32 to receive the first image and process it as a second image, then the second image is projected onto the partially transparent display screen 20 for displaying a third image 50 which can be seen by the observer 10.

Therefore, one feature of the present invention is that it includes a partially transparent display screen, an image sensor and a mainbody to make the observer to see his own processed image, and so as to achieve an electronic mirror having the function of image storage or process by utilizing the modern technology.

Accordingly, one advantage of the present invention is that the image of the observer may be magnified to a large-scale image by projection, thus the observer may comfortably see his own clear image when dressing or making up.

Please continuously refer to FIG. 1, in one embodiment, the partially transparent display screen 20 may be also a partially reflective display screen 20, the observer 10 may see his own image through the partially reflective screen 20 when the mainbody 40 is turned-off. Further, the mainbody 40 of the electronic mirror according to an embodiment of the present invention may include an image display device (not shown in the figure), and the partially reflective screen 20 will display the content provided by the image display device when the image display device is turned-on. Furthermore, the electronic mirror according to an embodiment of the present invention may include an object sensing device (not shown in the figure) to detect a user in the neighborhood of the partially reflective screen 20 to turn-on an image display device; the object sensing device may be a CMOS, a CCD, an Infrared (IR) thermal detecting device or an ultra-sonic detecting device in one embodiment.

Please continuously refer to FIG. 1, in one embodiment, the electronic mirror according to an embodiment of the present invention may further include a micro control unit (not shown in the figure) to process the aforementioned first image, for example, to magnify, deform, rotate or beautify the observer's image or add a background image to form the aforementioned second image.

Please continuously refer to FIG. 1, in one embodiment, the image sensor 30 is a CMOS or a CCD. Further, the mainbody 40 of the electronic mirror according to an embodiment of the present invention may include a switch (not shown in the figure) to turn-on or turn-off the mainbody 40 and the surface of the partially transparent display screen 20 that faces the observer 10 is partially reflective, thus the observer 10 can see the aforementioned third image 50 when the switch is turned-on and the electronic mirror is preformed as a regular mirror when the switch is turned-off.

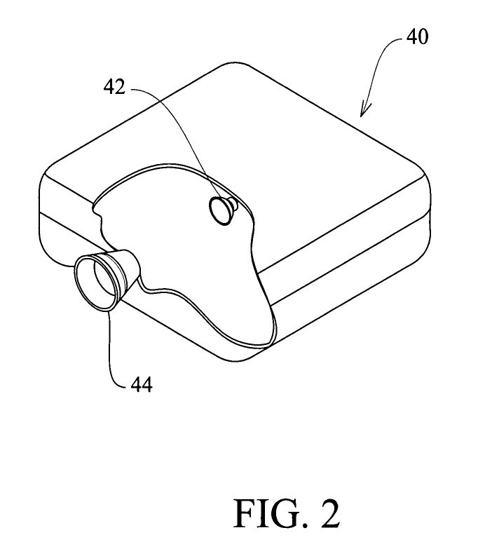

Please refer to FIG. 2, which is a structure schematic diagram of a mainbody 40 for the electronic mirror according to an embodiment of the present invention, the mainbody 40 of the electronic mirror according to an embodiment of the present invention may include a light source 42 and an image lens 44.

Please refer to FIG. 1 again, the mainbody 40 of the electronic mirror according to an embodiment of the present invention may include a data access module (not shown in the figure), such as a card insertion device, to receive and store an image data, and the mainbody 40 may project the image data as the aforementioned third image 50.

Please refer to FIG. 1 again, the mainbody 40 of the electronic mirror according to an embodiment of the present invention may include a voice module (not shown in the figure) that the observer 10 may interact with the mainbody 40 of the electronic mirror through the voice module, and the mainbody 40 may project a static or dynamic image as the aforementioned third image 50.

Please refer to FIG. 1 again, the mainbody 40 of the electronic mirror according to an embodiment of the present invention may include a network access module (not shown in the figure) to receive and store an image data from a network, and the mainbody 40 may project a static or dynamic image as the aforementioned third image 50. Further, different electronic mirrors may interchange and share the image data through the network access module and the network.

Please refer to FIG. 1 again, the mainbody 40 of the electronic mirror according to an embodiment of the present invention may be a front projection display, a rear projection display, a LCD projector, a film-type projector, a DLP projector or a LCOS projector.

To sum up, the electronic mirror according to the present invention may serve as an interactive apparatus with an observer, which has the advantages of observer interaction, simple structure and relative cheapness. Furthermore, the electronic mirror may be widely applied as a distance communication equipment, an entertainment appliance or a children toy.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. An electronic mirror, comprising:
a display device, wherein the display device is a partially transparent display screen;
an image sensor set on a surface of the partially transparent display screen to capture an image of an observer located in one side of the partially transparent display screen as a first image; and
a mainbody set in another side of the partially transparent display screen and electrically connected with the image sensor through a signal transmission line, wherein the mainbody comprises a projection device to receive the first image and process the first image as a second image, then to project the second image onto the partially transparent display screen for displaying a third image which can be seen by the observer.

2. The electronic mirror according to claim 1, wherein the display device is also a partially reflective screen, the observer may see his own image through the partially reflective screen when the mainbody is turned-off.

3. The electronic mirror according to claim 2, wherein the mainbody further comprises an image display device and the partially reflective screen will display the content provided by the image display device when the mainbody is turned-on.

4. The electronic mirror according to claim 3, further comprises an object sensing device to detect a user in the neighborhood of the partially reflective screen to turn-on the image display device.

5. The electronic mirror according to claim 4, wherein the object sensing device may be a CMOS, a CCD, an IR thermal detecting device or an ultra-sonic detecting device.

6. The electronic mirror according to claim 1, wherein the mainbody further comprises a micro control unit to magnify, deform, rotate or beautify the first image or add a background image to form the second image.

7. The electronic mirror according to claim 1, wherein the mainbody further comprises a switch that the electronic mirror is preformed as a regular mirror when the switch is turned-off.

8. The electronic mirror according to claim 1, wherein the mainbody comprises a light source and an image lens.

9. The electronic mirror according to claim 1, wherein the mainbody further comprises a data access module to receive and store an image data, which the electronic mirror may project the image data as the third image.

10. The electronic mirror according to claim 7, wherein the data access module is a card insertion device.

11. The electronic mirror according to claim 1, wherein the mainbody further comprises a voice module that the observer may interact with the mainbody through the voice module and the mainbody may project a static or dynamic image as the third image.

12. The electronic mirror according to claim 1, wherein the mainbody further comprises a network access module to receive and store an image data from a network, which the electronic mirror may project the image data as the third image and different electronic mirrors may interchange and share the image data through the network access module and the network.

13. The electronic mirror according to claim 1, wherein the mainbody is a front projection display, a rear projection display, an LCD projector, a DLP or an LCOS projector.

14. The electronic mirror according to claim 1, wherein the electronic mirror is a distance communication equipment, an entertainment appliance or a children toy.

15. The electronic mirror according to claim 1, wherein the image sensor is a CMOS or a CCD.
